(19) United States
(12) Patent Application Publication
(10) Pub. No.: US 2005/0108158 A1
(43) Pub. Date: May 19, 2005

(54) Method and system for remote purchase payments

(76) Inventor: Simon Prisant, Caisaria (IL)

Correspondence Address: NIXON & VANDERHYE, PC, 1100 N GLEBE ROAD, 8TH FLOOR, ARLINGTON, VA, 22201-4714, US

(21) Appl. No.: 10/694,389

(22) Filed: Oct. 28, 2003

Related U.S. Application Data
(63) Continuation of application No. 10/009,740, now abandoned.

(30) Foreign Application Priority Data
Jun. 16, 1999 (IL) 130505

(51) Int. Cl. G06F 17/60

(52) U.S. Cl. 705/40

(57) ABSTRACT

A method and system for remote purchase payment for items in a vending machine (10) or other automatic merchandise or service provider, utilizing a cellular phone (30), wherein the method comprises the steps of identifying an identifying feature of the cellular telephone (30), determining whether a desired transaction is available, carrying out the transaction by the automatic machine (30) and charging a transaction charge for, the transaction to the cellular telephone (30). The invention also includes a system for remote purchase payment from an automatic machine (10) comprising a cellular telephone (30) having an identifying feature, a communication interface (20) coupled to the automatic machine (10), an automatic transaction manager (36) coupled to the automatic machine (10) for carrying out the transaction by the automatic machine (10) and calculating a transaction charge.

### FIELD OF THE INVENTION

The present invention relates to a method and system for remote purchase payment, in general and, in particular, to a method and system for remote purchase payment by use of a cellular phone, for merchandise or services in vending and other automatic purchase machines.

### BACKGROUND OF THE INVENTION

Vending machines, and other automatic or automated service providers have long been known. These devices require the insertion of coins or bills to cover the cost of the purchase, which is counted as the coins are inserted into a coin receiving slot or the bills are inserted into a bill validator, in the machine.

These devices suffer from a number of drawbacks. First, they cannot be used unless the purchaser has cash, change or bills, often correct change. Second, the coin receiver or bill validator often malfunction, sometimes not registering receipt of coins or bills which were inserted, or rejecting coins or bills which are perfectly satisfactory. Third, they require potential purchasers to walk at all times with bills or quantities of coins. In addition, there is a high cost of cash handling e.g. collecting, transferring and counting the cash, and many stages at which theft can occur. Furthermore, the machine itself can be vandalized in order to remove any cash stored therein.

A variety of methods for remote purchase payment utilizing a debit card or credit card are known. These permit purchase of various items without requiring payment in cash, by presenting the card, instead, and the purchases are charged monthly to the account of the card holder. The details of the user's account can be read on a magnetic/chip card reader, or imprinted manually on a credit slip which is forwarded to the credit company. While these methods obviate the need for change or cash at all times, they still require the user to carry one or many cards, and to obtain a credit rating.

Among others, there is shown in U.S. Pat. No. 5,754,655 to Hughes et al, a system for remote purchase payment and remote bill payment transactions which includes a terminal for conducting remote bill payment transactions with a remote host computer. In one embodiment, this terminal includes a cellular phone integral to the terminal with a modem, for communicating with the remote host computer system. This device replaces a traditional computer terminal and keyboard and magnetic card reader at the point of purchase, but still requires the use of credit or debit card. In addition, since it includes a telephone and QWERTY keyboard, this device is relatively large and bulky.

There is shown in U.S. Pat. No. 5,728,999 to Teicher a vending machine which permits free access to a variety of merchandise. The machine selectively enables or bars free access of a plurality of customers to a variety of items in an accessible inventory stored therein, and charging for the item is carried out by a card payment system. The card payment system is capable of validating that the customer may be charged for the value of the entire inventory to which the customer has access, and charging the customer upon the purchase completion in accordance with the items he removed from the accessible inventory. The card payment system can interact with an electronic checkbook, credit card, bank debit card, a combo smart card, an electronic purse, and a local account card. In order to interact with all these cards, this vending machine requires a variety of programs and hardware to determine which card is utilized, to select the appropriate validation and charging method, and carry out remote or local validation and charging.

All these systems of payment via a payment card are associated with relatively costly procedures of communication, authorization, accounting and reporting, which are well known. Furthermore, these cards are subject to theft, and can be used by the thief for several days, until the card can be canceled. In addition, most credit card companies are unwilling to permit credit transactions for small sums of money. Other disadvantages include the fact that the cards can be forged, and that some 5% of credit card purchases are fraudulent.

Accordingly, there is a long felt need for a method for payment for items in a vending machine, which does not require cash, a credit card, or another bulky device.

### SUMMARY OF THE INVENTION

According to the present invention, there is provided a method for remote purchase payment from an automatic machine including establishing by use of a cellular phone, a telephone connection with the automatic machine, identifying an identifying feature of the cellular telephone, determining whether a selected transaction or service is available, carrying out the transaction or service by the automatic machine, and charging the transaction charge to that cellular telephone.

There is further provided in accordance with the present invention a system for remote purchase payment from an automatic machine including a conventional cellular telephone, a telephone interface coupled to the automatic machine, and an automatic transaction manager in the automatic machine for identifying an identifying feature of the cellular telephone, determining whether a selected transaction is available, and calculating a transaction charge to be charged to the cellular telephone.

### BRIEF DESCRIPTION OF THE DRAWINGS

The present invention will be further understood and appreciated from the following detailed description taken in conjunction with the drawings in which:

FIG. 1 is a schematic illustration of a system for remote purchase payment constructed and operative in accordance with one embodiment of the present invention;

FIG. 2 is a flow chart of the method for remote purchase payment according to the present invention; and

FIG. 3 is a flow chart of the operation of an automatic transaction manager in the system of the invention.

### DETAILED DESCRIPTION OF THE INVENTION

The present invention relates to a method and system for remote purchase payment for items in a vending machine or other automatic merchandise or service provider. Contrary to conventional systems, the present invention requires no cash, or credit card, or special equipment. Rather, it utilizes an item readily available to most purchasers at all times, namely, their cellular telephone. As cellular telephones become smaller and smaller, it is more and more convenient to carry one in one's pocket or on one's person at all times as well as in one's car.

According to the present invention, the user establishes a telephone connection via the cellular phone service provider, with the vending machine which identifies an identifying feature of the user's cellular phone provided by the service provider, and carries out the transaction.

Further, according to the present invention, the transaction charge for the purchase of an item or a service from an automatic device, or a payment at automatic tolls or parking, is charged to the account of the cellular telephone, and can be paid monthly along, with the user's telephone use charges. For this purpose, a suitable interface is provided in the automatic device for communicating with the cellular telephone. In the event that the items or services are not available, the charge is not registered to the cellular telephone's account, or is deleted before the end of the transaction. Optionally, a receipt can be provided via a printer.

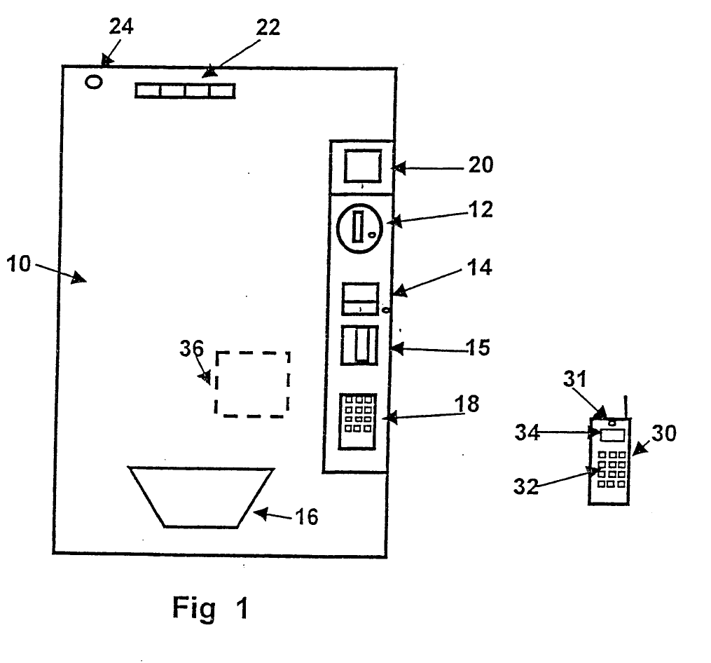

Referring now to FIG. 1, there is shown a schematic illustration of a system for remote purchase payment constructed and operative in accordance with one embodiment of the present invention, and including an automatic machine 10. Automatic machine 10 can be any automated vending machine for providing selectable items, or an automatic service provider, such as an automatic washing machine, or automatic tolls and parking, and particularly coin-operated machines of all sorts. It can include free access vending machines, and automatic machines such as gas pumps. In the illustrated embodiment, it can be seen that the device includes a coin receptacle 12, a bill validator 14, a card reader 15, a keypad 18 for providing the machine with data, such as data for selecting the desired item, and an item delivery area 16, all as known. Since such machines are well known in the art, they will not be described in further detail.

The present invention provides a communication interface 20, which includes any interface for facilitating exchange of information, such as a telephone interface for establishing a telephone connection between the automatic machine 10 and a conventional cellular telephone 30, having a keypad 32 and display 34, or an infra red interface for receiving infra red encoded PIN number from infra red transmitter 31 of cellular phone 30. Cellular telephone or cell phone 30 has at least one identifying feature, which is unique to that telephone, such as a phone number and/or code. This identifying feature can be associated with a transaction charge for later billing, as described in detail hereinbelow.

Automatic machine 10 further includes an automatic transaction manager 36 coupled to communication interface 20. Automatic transaction manager 36 performs the exchange of identification between the machine 10 and cellular phone 30, as well as authorizing the transaction, determining whether a selected transaction or service is available, carrying it out and registering the results of the transaction and the transaction charge.

It is a particular feature of the present invention that, prior to authorizing the transaction, the automatic transaction manager 36 verifies that the cellular phone 30 can be charged for the transaction, by identifying an identifying feature provided by the cellular phone service provider. Once verification is completed, the automatic transaction manager 36 disconnects the telephone call initiated by the purchaser, authorizes the carrying out of the transaction by the automatic machine 10, and charges the cellular phone 30 with a sum in accordance with the items removed from the vending machine 10 or the services utilized. This can be accomplished by any sensing means for sensing the removal of each item from the inventory stored in a storage and display unit or the providing of the service or the payment of the toll or parking, as known.

The cellular phone service provider can indicate that transaction charges can be charged to the account of a particular cellular telephone, in any fashion. Preferably, this is accomplished in such a way that it is not required to contact the cellular phone service provider at the time of each purchase, although this is also a possible method. One preferred method of indicating approval of a transaction is utilizing the so called “Caller ID”, a call-screening feature on some phones that displays the phone number and/or the name of a caller. This is a service provided by the phone service provider which enables a cellular phone receiving an incoming call to identify the person or telephone placing the call. Once the Caller ID service is provided, the cellular owner can switch this service feature on and off, at will. If the cellular phone is lost or stolen or its owner no longer desires to use it for purchasing, the phone service provider can discontinue the Caller ID service immediately following a notice from the cellular phone owner. This service can be utilized by the automatic transaction manager 36 as an identifying feature of a potential purchaser's cellular telephone. Hence, when a purchaser desires to purchase merchandise in an automatic machine, he dials a phone number associated with the particular vending machine, optionally displayed on the machine 10 by a scrolling LCD or other display 22. If the purchaser's cellular phone has the caller ID option, the automatic transaction manager 36 will receive an indication of the identity of the caller. If the automatic transaction manager 36 is capable of identifying the calling cellular telephone 30, this serves as an indication that this particular cellular phone owner is permitted to carry out purchase transactions using his or her cellular phone. Once the automatic transaction manager 36 identified an authorized cellular phone, it authorizes the transaction and disconnects the telephone call initiated by the purchaser. Optionally, automatic transaction manager 36 advises the potential purchaser by sending him a pre-recorded message or by illuminating an indication light 24 mounted on machine 10, that he may proceed with the transaction. The purchaser then selects the desired items via keypad 18, and automatic transaction manager 36 carries out the transaction, and charges the cost of the transaction to the identified caller telephone. In this case, the phone service provider gives blanket permission for all transactions.

Alternatively, or in addition, each phone number associated with the machine can be provided with a code number, which is dialed by the purchaser or automatically annexed by the service provider, when dialing the machine number, whereby access is granted by the telephone service provider only to certain cellular phone users to those machines having certain codes. If additional identification of the caller is desired, a Personal Identification Number (PIN number) can be required to be submitted, (e.g., input via keypad 32 of the cellular telephone 30 or keypad 18 of machine 10, once the telephone call initiated by the purchaser has been disconnected).

According to a preferred embodiment of the invention, the PIN number is automatically and covertly annexed by the cellular phone service provider to the telephone number associated with machine 10, during the dialing thereof by the purchaser. Once the telephone connection is established between cellular phone 30 and communication interface 20, the automatic transaction manager 36 can require, preferably by a pre-recorded message, that the purchaser submit the PIN number within a given time period, which can be done via the keypad 32 or the machine keypad 18, once the telephone call initiated by the purchaser has been disconnected. When the purchaser submits the PIN number, it is compared by automatic transaction manager 36 to the PIN number covertly annexed by the service provider to the machine number. If a match is detected within the given time period, automatic transaction manager 36 authorizes the transaction. If no match is detected or the given time period elapsed, automatic transaction manager 36 disconnects the telephone call initiated by the purchaser's cellular phone 30.

According to another preferred embodiment of the invention, the purchaser dials the PIN number, immediately following the dialing of the telephone number associated with machine 10, and the automatic transaction manager automatically compares the PIN number as in the above described preferred embodiment, and authorizes the transaction or disconnects the purchaser 's cellular telephone call, if no match is detected, as described above.

According to yet another preferred embodiment of the invention, the potential purchaser can call a special number of the telephone service provider, which is capable of identifying his cellular telephone. If the caller is identified and the purchases are authorized, the telephone service provider can send a code number back to the caller which will be recognized by the vending machine as identification of the cellular phone, or the telephone service provider can send authorization directly to the automatic transaction manager 36 of the particular vending machine, for that transaction.

It is a particular feature of the present invention that the transaction cost is charged directly to the account of the cellular telephone holder. In this way, the user never needs to carry cash or coins for purchasing from automatic devices, and the billing can be arranged in the same manner as a conventional cellular telephone bill, with the addition of the added transaction charges. Since telephone bills often include small sums, the handling of purchases for small amounts is not a problem and does not unreasonably increase billing costs.

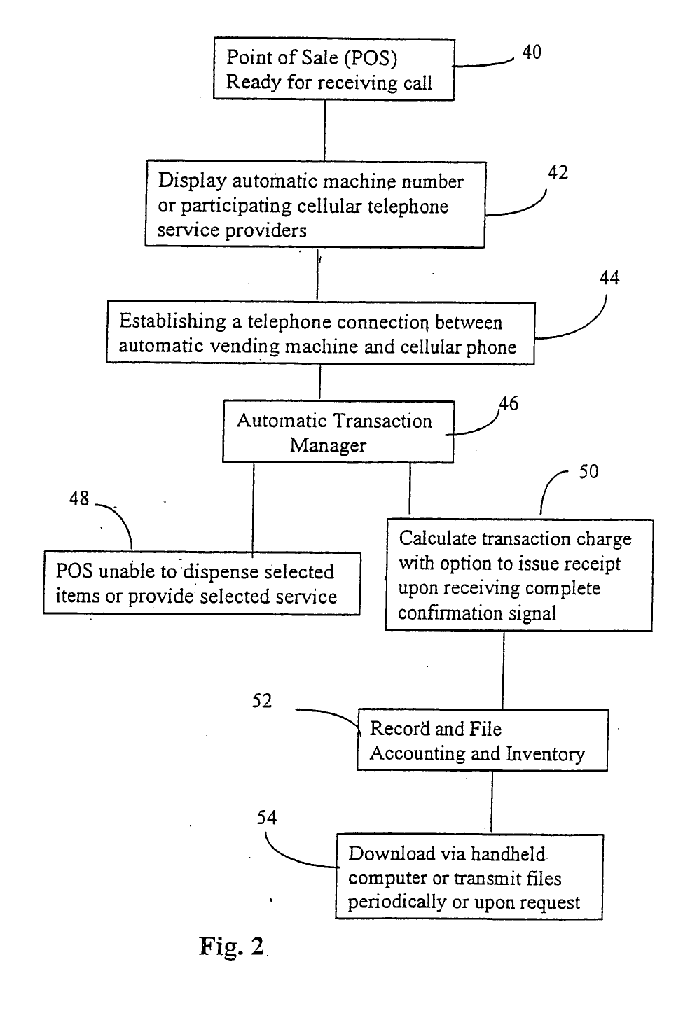

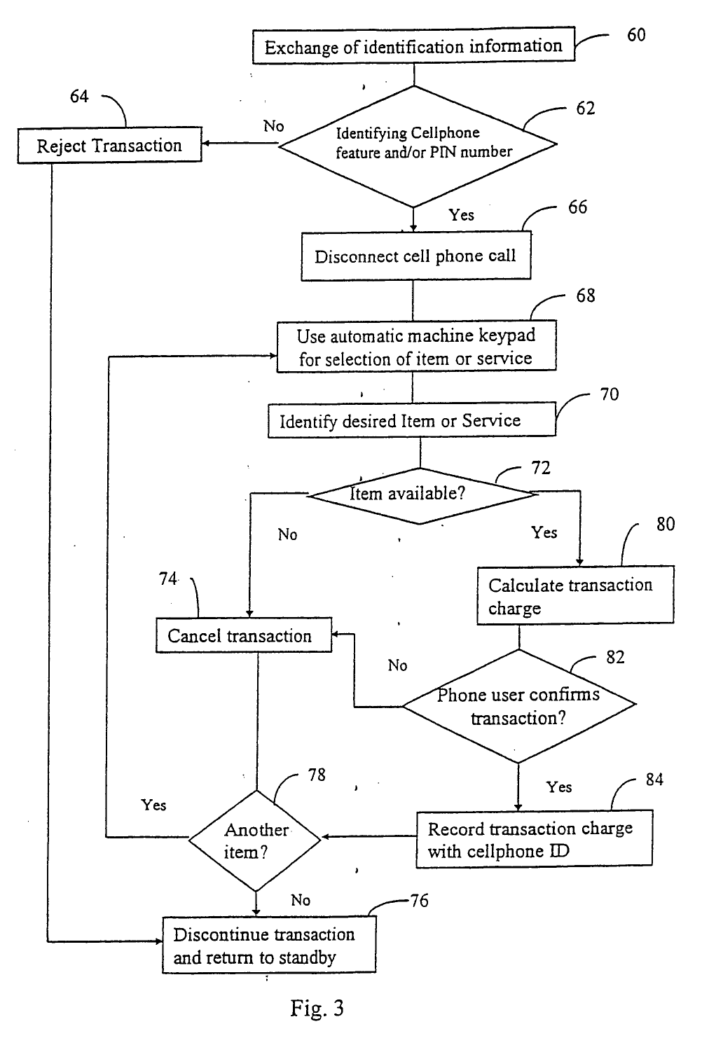

Operation of the system of the present invention is as follows. Referring to FIG. 2, there is shown a flow chart of the method for remote purchase payment according to the present invention. When a purchaser arrives at the point of sale (POS), the automatic device at the point of sale is ready to receive a call (block 40). According to one embodiment of the invention, the automatic device includes a display 22 for displaying the identification number of the machine or a toll-free number of a participating cellular telephone service provider (block 42). When the purchaser dials on his cellular phone the identification number of the machine or the toll-free number displayed on the machine, a telephone connection is established between cellular phone 30 and communication interface 20 un automatic machine 10 (block 44), for the exchange of identification information. Alternatively, cellular phone keypad 32 is used to send via infra red transmitter 31, encoded PIN number to communication interface 20. Automatic transaction manager 36 (block 46) is responsible for carrying out the identification, authorizing the transaction, disconnecting the cellular telephone call, determining whether a selected transaction or service is available, dispensing thereof and performing the charging procedure. Operation of the automatic transaction manager is illustrated schematically in FIG. 3. Following the establishing of a telephone connection between communication interface 20 and cellular phone 30, automatic transaction manager 36 performs the exchange of identification information between the cellular phone and the machine (block 60).

According to one embodiment of the invention, as described above, the purchaser's cellular telephone is identified by the automatic transaction manager by means of the Caller ID feature or any other feature provided by the telephone service provider or in any other manner. Optionally, the purchaser is prompted to submit a PIN number, or other identification number, so as to prevent purchases by an unauthorized telephone user. The automatic transaction manager identifies the particular feature of the cellular phone and additionally, in a preferred embodiment of the invention, verifies the PIN number (block 62).

According to another embodiment of the invention, keypad 32 of cellular phone 30 is used to send infra red encoded PIN number to communication interface 20, via infra red transmitter 31. Then, automatic transaction manager 36 requires that the purchaser submit the PIN number within a given time period, which can be done via machine keypad 18 or cell phone keypad 32. When the purchaser submits the PIN number, it is compared by automatic transaction manager 36 to the encoded PIN number transmitted by infra red transmitter 31. If a match is detected within the given time period, automatic transaction manager 36 authorizes the transaction.

If the cellular telephone is not identified by the automatic transaction manager 36, or in addition the PIN number is not verified, the transaction is rejected (block 64), the transaction is discontinued and automatic machine 10 returns to its standby state (block 76).

If the cellular telephone is identified, or in addition, the PIN number is verified, cell phone call is disconnected (block 66) and the transaction proceeds. Using machine keypad 18, or in any other suitable manner, the user indicates the desired purchase or service (block 68), which is identified by the automatic transaction manager (block 70). The automatic transaction manager determines whether the item or service is available, as by checking an inventory list stored in the memory of the automatic machine or the automatic transaction manager.

If the item or service is not available (block 72), the transaction is canceled (block 74) and the automatic transaction manager prompts machine 10 to return to its standby state (block 76). Alternatively, the automatic transaction manager can inquire, optionally by a pre-recorded message, whether another item or service is desired, instead (block 78). If so, it receives data provided by the purchaser via keypad 18 (block 68), identifies the desired service or item (block 70), and continues as described above.

If the item or service is available (block 72), the automatic transaction manager determines or calculates the transaction charge (block 80). The cell phone user is requested to confirm the transaction (block 82). If the transaction is not confirmed, the transaction is canceled (block 74). If the transaction is confirmed, the transaction is recorded (block 84) and the service or item is provided. The automatic transaction manager preferably inquires whether another item or service is desired (block 78). If so, it continues as described above. If not, the automatic transaction manager prompts machine 10 to return to its standby state (block 76).

It will be appreciated that the order of operations of the automatic transaction manager can be changed. For example, an additional item can be selected after confirmation of a transaction and, after all the items have been selected, the total transaction charge can be recorded. Or, a plurality of items can be selected before the transaction charge is calculated and sent to the purchaser for confirmation.

Referring again to FIG. 2, it is shown in block 50 that the transaction charge is calculated, and that optionally a receipt can be issued via a printer, if a printer has been installed in the automatic device. The transaction charge is then recorded and filed in the automatic transaction manager and the inventory in the automatic device is updated so that the automatic transaction manager knows what items or services are available (block 52).

The filed transaction charges with associated cell phone numbers can be downloaded via a hand-held computer (block 54) or transmitted on-line periodically or on request to a central data base, generally that of the cellular telephone service provider. The phone service provider can then bill the user for all automatic purchases and transactions, in the same manner that it bills the use of the cellular phone. In this way, the user pays once a month for all small purchases from automatic machines, and is freed from the drudgery of hoarding and carrying many coins or bills for this purpose. If the automatic transaction manager is unable to complete the transaction (block 48), the charge is not registered to the cellular telephone's account, or is deleted before the end of the transaction.

It will be appreciated that the invention is not limited to what has been described hereinabove merely by way of example. Rather, the invention is limited solely by the claims which follow.

1. A method for remote purchase payment from an automatic machine comprising the steps of:
contacting the automatic machine with a cellular telephone;
identifying an identifying feature of the cellular telephone;
determining whether a desired transaction is available;
carrying out said transaction by the automatic machine; and
charging a transaction charge for said transaction to said cellular telephone.

2. The method according to claim 1, wherein said step of identifying is carried out by a cellular telephone service provider.

3. The method according to claim 1, wherein said step of carrying out a transaction includes providing merchandise from a vending machine.

4. The method according to claim 2, wherein said step of carrying out a transaction includes providing merchandise from a vending machine.

5. The method according to claim 1, wherein said step of carrying out a transaction includes providing a service from an automatic service provider.

6. The method according to claim 2, wherein said step of carrying out a transaction includes providing a service from an automatic service provider.

7. The method according to claim 1, wherein said step of identifying includes:
identifying said cellular telephone by means of an identifying feature provided by a cellular telephone service provider.

8. The method according to claim 1, wherein said identifying feature is a Caller ID service provided by a cellular telephone service provider.

9. The method according to claim 1, wherein said step of identifying includes:
connecting with said cellular telephones; and,
comparing said identifying feature with permitted identifying features.

10. The method according to claim 9, wherein said
connection with said cellular phone is disconnected following said step of identifying.

11. The method according to claim 9, wherein said of identifying further includes:
requesting a PIN number; and,
comparing said PIN number with PIN number covertly provided by said cellular telephone service provider to said automatic machine during said connecting step.

12. The method according to claim 9, wherein said step of identifying includes:
submitting a PIN number; and,
comparing said PIN number with PIN number covertly provided by said cellular telephone service provider to said automatic machine during said connecting step.

13. The method according to claim 1, wherein said:
cellular phone is disconnected following said step of identify.

14. The method according to claim 12, wherein said:
connection with said cellular phone is disconnected following said step to identifying.

15. The method according to claim 14, wherein said step of identifying includes: connecting with said cellular telephone by infra red means;
requesting a PIN number; and,
comparing said PIN number with encoded PIN number provided by cellular telephone infra red transmitter to said automatic machine during said connecting step.

16. The method according to claim 1, wherein said step of identifying includes:
connecting with said cellular telephone by infra red means;
submitting a PIN number; and,
comparing said PIN number with encoded PIN number provided by cellular telephone infra red transmitter to said automatic machine during said connecting step.

17. The method according to claim 1, wherein said step of carrying out includes:
identifying a desired transaction;
determining whether said desired transaction is available.

18. The method according to claim 17, wherein said step of carrying out further includes requesting confirmation of said transaction.

19. The method according to claim 1, wherein said step of charging includes:
identifying a desired transaction;
calculating a transaction charge associated with said desired transaction; and
recording said calculated transaction charge in association with said identifying feature of said cellular telephone.

20. The method according to claim 1, wherein said step of charging includes:
identifying a desired transaction;
calculating a transaction charge associated with said desired transaction:, and recording said calculated transaction charge in association with said PIN number.

21. The system for remote purchase payment from an automatic machine comprising:
a cellular telephone having an identifying feature;
a communication interface coupled to the automatic machine;
an automatic transaction manager coupled to the automatic machine for identifying said identifying feature of said cellular telephone, recording said identifying feature, identifying a selected transaction, determining availability of said selected transaction, carrying out said transaction by said automatic machine and calculating a transaction charge; and
charging means associated with said automatic transaction manager for associating said charge with said identifying feature of said telephone.

22. The system according to claim 21, wherein said automatic transaction manager is further adapted to verify PIN number of said cellular telephone user.

23. A system for remote purchase payment from an automatic machine comprising:
a cellular telephone having infra red means;
a communication interface coupled to the automatic machine;
an automatic transaction manager coupled to the automatic machine for verifying a PIN number of said cellular telephone user, recording said PIN number, identifying a selected transaction, determining availability of said selected transaction, carrying out said transaction by said automatic machine and calculating a transaction charge; and
charging means associated with said automatic transaction manager for associating said charge with said PIN number of said telephone user.

24. The system according to claim 21, wherein said automatic transaction manager includes:
means for identifying an identifying feature of said cellular telephone; means for recording said identifying feature;
means for identifying a selected transaction;
means for determining availability of said selected transaction;
means for calculating a transaction charge associated with said selected transaction; and
means for storing said transaction charge in association with said cellular telephone identifying feature.

25. The system according to claim 24, wherein said automatic transaction manager further includes means for verifying a PIN number.

26. The system according to claims 23 wherein said automatic transaction manager includes:
means for verifying a PIN number; means for recording said PIN number; means for identifying a selected transaction;
means for determining availability of said selected transaction;
means for calculating a transaction charge associated with said selected transaction; and
means for storing said transaction charge in association with said PIN number.

27. (canceled).
